(19) United States
(12) Patent Application Publication
(10) Pub. No.: US 2024/0395278 A1
(43) Pub. Date: Nov. 28, 2024

(54) UNIVERSAL SPEECH ENHANCEMENT USING GENERATIVE NEURAL NETWORKS

(71) Applicant: DOLBY INTERNATIONAL AB, Dublin (IE)

(72) Inventors: Joan SERRA, Barcelona (ES); Santiago PASCUAL, Barcelona (ES); Jordi PONS PUIG, Olot (ES)

(73) Assignee: DOLBY INTERNATIONAL AB, Dublin (IE)

(21) Appl. No.: 18/696,229

(22) PCT Filed: Sep. 29, 2022
(86) PCT No.: PCT/EP2022/077144

§ 371 Date: Mar. 27, 2024

Related U.S. Application Data
(60) Provisional application No. 63/392,575, filed on Jul. 27, 2022.
(60) Provisional application No. 63/287,207, filed on Dec. 8, 2021.

(30) Foreign Application Priority Data
Sep. 29, 2021 (ES) P202130914
May 18, 2022 (ES) P202230427

(51) Int. Cl. G10L 21/0216; G10L 25/30

(52) U.S. Cl. CPC G10L 21/0216; G10L 25/30

(57) ABSTRACT

The disclosure relates to a neural network based system for speech enhancement, comprising a generative network for generating an enhanced audio signal and a conditioning network for generating conditioning information for the generative network. The conditioning network comprises a plurality of layers and is configured to receive an audio signal as input: propagate the audio signal through the plurality of layers; and provide one or more first internal representations of the audio signal or processed versions thereof as the conditioning information, wherein the one or more first internal representations of the audio signal are extracted at respective layers of the conditioning network. The generative network is configured to receive a noise vector and the conditioning information as input; and generate the enhanced audio signal based on the noise vector and the conditioning information. The disclosure further relates to a method of training the system.

This application claims priority of the following priority applications: Spanish Patent Application No. P202130914, filed Sep. 29, 2021 (reference no. D21101ES), U.S. Provisional Patent Application No. 63/287,207, filed Dec. 8, 2021 (reference no. D21101USP1), and U.S. Provisional Patent Application No. 63/392,575, filed Jul. 27, 2022 (reference no. D21101USP2), the contents of each of which are incorporated by reference in its entirety.

### TECHNICAL FIELD

The present disclosure relates to neural network based techniques for speech enhancement of audio signals and to training of neural network based systems for speech enhancement. In particular, the present disclosure relates to such techniques that can remove a variety of artifacts from noisy audio signals containing speech, in addition to denoising the audio signals. These techniques may relate to generative models or generative networks (or generative techniques in general).

### BACKGROUND

Speech recordings or streams, specifically those produced by non-professionals or with low-end devices, contain background noise that can seriously affect the quality of the recording and, ultimately, prevent the understanding of what is being said. This motivates the development of speech denoising or enhancement algorithms, which try to filter out the noise components without compromising the naturalness of speech. Another artifact that can be found in these cases, specifically if the speaker is inside a room, is reverberation. Hence, it would be advantageous for speech enhancement algorithms to move away from simple denoising towards tackling both background noise and reverberation. Moreover, speech recordings or streams can contain additional artifacts beyond noise and reverb, which, for example, may include clipping, silent gaps, equalization, wrong levels, and codec artifacts.

There is thus a need for an improved (e.g., universal) speech enhancement techniques that can remove any or all of these artifacts in a single step.

### SUMMARY

In view of this need, the present disclosure provides neural network based systems for speech enhancement, methods of processing an audio signal for speech enhancement using neural network based systems, methods of training neural network based systems, computer programs, and computer-readable storage media, having the features of the respective independent claims.

An aspect of the present disclosure relates to a neural network based system for speech enhancement of an audio signal. The neural network based system may be computer-implemented, for example. The system may include a generative network for generating an enhanced audio signal and a conditioning network for generating conditioning information for the generative network. The conditioning network may include a plurality of layers (e.g., convolutional layers). Further, the conditioning network may be configured to receive the audio signal as input. The conditioning network may be further configured to propagate the audio signal through the plurality of layers. The conditioning network may be yet further configured to provide one or more first internal representations of the audio signal (or processed versions of the one or more first internal representations) as the conditioning information. The one or more first internal representations of the audio signal may be extracted at respective layers of the conditioning network. The generative network may be configured to receive a noise vector and the conditioning information as input. The generative network may be further configured to generate the enhanced audio signal based on the noise vector and the conditioning information.

Configured as described above, comprising a generative network that processes a random vector and a conditioning network that processes the audio signal and generates conditioning information for the generative network, the proposed system is capable of enhancing speech by not only denoising the speech signal, but by removing all sorts of artifacts that could be present in the speech signal, including clipping, gaps, equalization, wrong levels, and codec artifacts.

In some embodiments, the first internal representations of the conditioning information may relate to a hierarchy of representations of the audio signal, at different temporal resolutions. This allows to transfer information on characteristics of the audio signal at different granularities to the generative network, to ensure a natural result for the enhanced audio signal.

In some embodiments, each first internal representation of the conditioning information (or a processed version thereof) may be combined with a respective second internal representation in the generative network. Here and in the following, combining internal representations (e.g., for purposes of conditioning) may include one or more of addition, multiplication, and concatenation, for example. In some implementations, the combination of internal representations may use addition and multiplication.

In some embodiments, the conditioning network may be further configured to receive first side information as input. Then, processing of the audio signal by the conditioning network may depend on the first side information.

The first side information may provide the conditioning network with additional information on the audio signals that are to be enhanced, thereby providing the system with greater adaptability to different kinds of audio signals.

In some embodiments, the first side information may include a numeric or textual description of one or more of: a type of artifact present in the audio signal, a level of noise present in the audio signal, an enhancement operation to be performed on the audio signal, and information on characteristics of the audio signal. Characteristics of the audio signal may include one or more of a speaker identity, language information, a room characteristic, and a microphone characteristic, for example.

In some embodiments, the generative network may be further configured to receive second side information as input. Then, processing of the noise vector by the generative network may depend on the second side information.

The second side information may provide the generative network with additional information on the audio signals that are to be enhanced, thereby providing the system with greater adaptability to different kinds of audio signals.

In some embodiments, the second side information may include a numeric or textual description of one or more of: a type of artifact present in the audio signal, a level of noise present in the audio signal, an enhancement operation to be performed on the audio signal, and information on characteristics of the audio signal. Characteristics of the audio signal may include one or more of a speaker identity, language information, a room characteristic, and a microphone characteristic, for example.

In some embodiments, the plurality of layers of the conditioning network may include one or more intermediate layers. Further, the one or more first internal representations of the audio signal may be extracted from the one or more intermediate layers.

In some embodiments, the conditioning network may be based on an encoder-decoder structure. Optionally, the encoder-decoder structure may use ResNets. Additionally or alternatively, the encoder part of the encoder-decoder structure may include one or more skip connections.

In some embodiments, the generative network may be based on an encoder-decoder structure. Optionally, the encoder-decoder structure may use ResNets. Additionally or alternatively, the encoder part of the encoder-decoder structure may include one or more skip connections. For example, the generative network may be based on a UNet structure. Optionally, the UNet structure may include one or more of skip connections in inner layers, residual connections in inner layers, and a recurrent neural network.

In some embodiments, the generative network may be based on one of a diffusion-based model, a variational autoencoder, an autoregressive model, or a Generative Adversarial Network formulation.

In some embodiments, the system may have been trained prior to inference, using data pairs each comprising a clean audio signal and a distorted audio signal corresponding to or derived from the clean audio signal. Therein, the distorted audio signal may include noise and/or artifacts.

In some embodiments, one or more of the data pairs may include a respective clean audio signal and a respective distorted audio signal that has been generated by programmatic transformation of the clean audio signal and/or addition of noise. For example, the programmatic transformation may introduce artifacts or distortion relating to any or all of band limiting, codec artifacts, signal distortion, dynamics, equalization, recorded noise, reverb/delay, spectral manipulation, synthetic noise, and transmission artifacts.

Using data pairs that are generated in this manner allows to train the system to remove specific artifacts, corresponding to the programmatic transformation and/or specific noise.

In some embodiments, the conditioning network may be further configured to provide one or more third internal representations of the audio signal for training. Therein, the one or more third internal representations of the audio signal may be extracted at respective layers of the conditioning network. Further, the system may have been trained, for each data pair, based on a comparison of the clean audio signal to an output of the system when the distorted audio signal is input to the conditioning network as the audio signal, and further based on a comparison of representations of the clean audio signal or audio features derived from the clean audio signal to the third internal representations, after processing of the third internal representations by internal layers and/or respective auxiliary neural networks.

In some embodiments, the comparisons may be based on respective loss functions. These loss functions may relate to one or more of negative log-likelihoods, Lp norms, maximum mean discrepancy, adversarial losses, and feature losses.

In some embodiments, the audio features may include at least one of mel band spectral representations, loudness, pitch, harmonicity/periodicity, voice activity detection, zero-crossing rate, self-supervised features from an encoder, self-supervised features from a wave2vec model, and self-supervised features from a HuBERT model.

In some embodiments, there may be one respective auxiliary neural network for each third internal representation extracted from the conditioning network.

In some embodiments, the one or more auxiliary neural networks may be based on mixture density networks.

In some embodiments, the conditioning network and the generative network may have been jointly trained.

Another aspect of the disclosure relates to a method of processing an audio signal for speech enhancement using a neural network based system. The method may be computer-implemented, for example. The system may include a generative network for generating an enhanced audio signal and a conditioning network for generating conditioning information for the generative network. The method may include inputting the audio signal to the conditioning network. The method may further include propagating the audio signal through a plurality of layers (e.g., convolutional layers) of the conditioning network. The method may further include extracting one or more first internal representations of the audio signal at respective layers of the conditioning network and providing the one or more first internal representations of the audio signal (or processed versions of the one or more first internal representations) as the conditioning information. The method may further include inputting a noise vector and the conditioning information to the generative network. The method may yet further include generating the enhanced audio signal based on the noise vector and the conditioning information.

In some embodiments, the first internal representations of the conditioning information may relate to a hierarchy of representations of the audio signal, at different temporal resolutions.

In some embodiments, the method may further include combining each first internal representation of the conditioning information (or a processed version thereof) with a respective second internal representation in the generative network. Combining internal representations may include one or more of addition, multiplication, and concatenation, for example.

In some embodiments, the method may further include inputting first side information to the conditioning network and/or inputting second side information to the generative network.

Another aspect of the disclosure relates to a method of training the neural network based system of the above first aspect or any of its embodiments. The training may be based on data pairs each comprising a clean audio signal and a distorted audio signal corresponding to or derived from the clean audio signal. Therein, the distorted audio signal may include noise and/or artifacts.

In some embodiments, one or more of the data pairs may include a respective clean audio signal and a respective distorted audio signal that has been generated by programmatic transformation of the clean audio signal and/or addition of noise. In some cases, the programmatic transformation of the clean audio signal may correspond to addition of artifacts.

In some embodiments, the method may further include, for each data pair, inputting the distorted audio signal to the conditioning network as the audio signal. The method may further include, for each data pair, propagating the audio signal through the plurality of layers of the conditioning network. The method may further include, for each data pair, extracting the one or more first internal representations of the audio signal at the respective layers of the conditioning network and providing the one or more first internal representations of the audio signal (or processed versions of the one or more first internal representations) as the conditioning information. The method may further include, for each data pair, extracting one or more third internal representations of the audio signal at respective layers of the conditioning network. The method may further include, for each data pair, processing each of the third internal representations by a respective auxiliary neural network. The method may further include, for each data pair, inputting the noise vector and the conditioning information to the generative network. The method may further include, for each data pair, generating, using the generating network, an output of the system based on the noise vector and the conditioning information. The method may further include, for each data pair, comparing the output of the system to the clean audio signal. The method may yet further include, for each data pair, comparing the third internal representations, after processing by the auxiliary neural networks, to representations of the clean audio signal or audio features derived from the clean audio signal.

In some embodiments, comparing the output of the system to the clean audio signal and comparing the third internal representations to representations of the clean audio signal or audio features derived from the clean audio signal may be based on respective loss functions. These loss functions may relate to one or more of negative log-likelihoods, Lp norms, maximum mean discrepancy, adversarial losses, and feature losses.

In some embodiments, the audio features may include at least one of mel band spectral representations, loudness, pitch, harmonicity/periodicity, voice activity detection, zero-crossing rate, self-supervised features from an encoder, self-supervised features from a wave2vec model, and self-supervised features from a HuBERT model.

In some embodiments, the one or more auxiliary neural networks may be based on mixture density networks.

In some embodiments, the conditioning network, the generative network, and the one or more auxiliary neural networks may be jointly trained.

According to another aspect, an apparatus for speech enhancement of an audio signal is provided. The apparatus may include a processor and a memory coupled to the processor and storing instructions for the processor. The processor may be configured to perform all steps of the methods according to preceding aspects and their embodiments.

According to a further aspect, a computer program is described. The computer program may comprise executable instructions for performing the methods or method steps outlined throughout the present disclosure when executed by a computing device (e.g., processor).

According to another aspect, a computer-readable storage medium is described. The storage medium may store a computer program adapted for execution on a computing device (e.g., processor) and for performing the methods or method steps outlined throughout the present disclosure when carried out on the computing device.

It should be noted that the methods and systems including its preferred embodiments as outlined in the present disclosure may be used stand-alone or in combination with the other methods and systems disclosed in this document. Furthermore, all aspects of the methods and systems outlined in the present disclosure may be arbitrarily combined. In particular, the features of the claims may be combined with one another in an arbitrary manner.

It will be appreciated that apparatus features and method steps may be interchanged in many ways. In particular, the details of the disclosed method(s) can be realized by the corresponding apparatus, and vice versa, as the skilled person will appreciate. Moreover, any of the above statements made with respect to the method(s) (and, e.g., their steps) are understood to likewise apply to the corresponding apparatus (and, e.g., their blocks, stages, units), and vice versa.

### BRIEF DESCRIPTION OF THE DRAWINGS

The invention is explained below in an exemplary manner with reference to the accompanying drawings, wherein

FIG. 1 schematically illustrates an example of a neural network based system according to embodiments of the disclosure;

FIG. 2 is a flowchart illustrating an example of a method of processing an audio signal using the neural network based system of FIG. 1, according to embodiments of the disclosure;

FIG. 3 schematically illustrates an example of a neural network based system during training, according to embodiments of the disclosure;

FIG. 4 is a flowchart illustrating an example of a method of training the neural network based system of FIG. 3, according to embodiments of the disclosure; and

FIG. 5 schematically illustrates an example of an apparatus for implementing neural network based systems and neural network based techniques according to embodiments of the disclosure.

### DETAILED DESCRIPTION

In the following, example embodiments of the disclosure will be described with reference to the appended figures. Identical elements in the figures may be indicated by identical reference numbers, and repeated description thereof may be omitted.

The present disclosure relates to systems and methods for universal speech enhancement. These systems and methods embrace all real-world possibilities and combinations of removing artifacts. As this new task involves generating speech where there was previously no speech (for example when an audio signal contains clipping or silent gaps), a generative system is needed that, given proper context and internal cues, generates a realistic speech signal that corresponds to an original, clean speech signal. The present disclosure presents such generative systems.

The generation may be performed using a generative neural network, which is a machine learning technique that, given a conditioning signal and a random noise source, can generate realistic speech that matches the fine-grained characteristics and content of speech that was present in the noisy/distorted source. As described in more detail below, the generative network only needs the conditioning signal and a noise vector as inputs. The conditioning signal in turn is obtained based on noisy/distorted speech using a conditioning network.

For training, the presented speech enhancement techniques may rely, possibly in addition to manually generated training data, on programmatically-generated training data. For programmatically-generated training data, pairs of signals (y*,y) are created from a pool of clean speech and noise data sets, where y* is a random excerpt of some clean speech signal and y is a mixture of y* with a random excerpt of a real or synthetic noise signal using a random signal-to-noise ratio or a mixture of y* with added artifact(s), such as low-pass filtering, for example. Importantly, the signal y* used in the creation of y can undergo a number of programmatic transformations before or after being mixed with the noise signal. Such transformations can for example include one or more of adding reverberation (synthetic or from simulated/real room impulse responses), low-pass filtering, clipping, packet loss simulation, transcoding, random equalization, level dynamics distortion, etc.

Thus, training the model or system described in the present disclosure may be said to use a data set of clean and programmatically-distorted pairs of speech recordings. Additionally (or alternatively), training may use a data set of clean speech recordings and distorted speech recordings recorded in a real-life environment which are time-aligned (i.e., without delay between the recordings).

In one example, to obtain the clean speech, a certain amount of audio (e.g., 1,500 hours of audio) may be sampled from an audio pool (e.g., internal pool) of data sets and converted to a certain sampling rate (e.g., 16 kHz mono). For example, the sample may consist of a large number (e.g., about 1.2 million) of utterances of few seconds length (e.g., between 3.5 and 5.5 s), from a large number of speakers, and/or in several languages, and/or with several different recording conditions.

For example, clean utterances sampled from VCTK and Harvard sentences may be used, together with noises/backgrounds from DEMAND and FSDnoisy18 k. To programmatically generate distorted speech (e.g., by addition of artifacts), a plurality of distortion families or classes may be considered. These may include, for example, any or all of band limiting, codec artifacts, signal distortion, dynamics, equalization, recorded noise, reverb/delay, spectral manipulation, synthetic noise, and transmission artifacts. Each distortion family may include a variety of distortion algorithms, which may be generically called ‘types’. For instance, types of band limiting may include band pass filter, high pass filter, low pass filter, and/or downsample. Types of codec artifacts may relate to the AC3 codec, EAC3 codec, MP2 codec, MP3 codec, Mu-law quantization, OGG/Vorbis codec, OPUS codec 1, and/or OPUS codec 2, for example. Types of distortion may include more plosiveness, more sibilance, overdrive, and/or threshold clipping, for example. Types of dynamics may include compressor, destroy levels, noise gating, simple compressor, simple expansor, and/or tremolo, for example. Types of equalization may include band reject filter, random equalizer, and/or two-pole filter, for example. Types of recorded noise may include additive noise and or impulsional additive noise, for example. Types of reverb/delay may include algorithmic reverb (e.g., 1 or 2), chorus, phaser, RIR convolution, very short delay, delay, and/or room impulse responses (e.g., real and/or simulated), for example. Types of spectral manipulation may include convolved spectrogram, Griffin-Lim, phase randomization, phase shuffle, spectral holes, and/or spectral noise, for example. Types of synthetic noise may include colored noise, DC component, electricity tone, non-stationary noise bursts (e.g., non-stationary colored noise, non-stationary DC component, non-stationary electricity tone, non-stationary random tone), and/or random tone, for example. Types of transmission artifacts may include frame shuffle, insert attenuation, insert noise, perturb amplitude, sample duplicate, silent gap (packet loss), and/or telephonic speech, for example. Distortion type parameters such as strength, frequency, filter characteristics, bit rate, codec configuration, gain, harmonicity, ratio, compressor characteristics, SNR, reverb characteristics, etc. may be set randomly for the above distortion families and types.

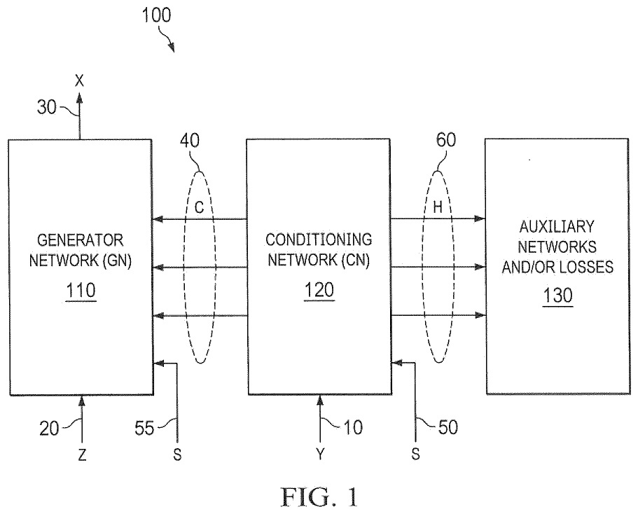

FIG. 1 schematically illustrates a neural network based system 100 for speech enhancement (e.g., universal speech enhancement) according to embodiments of the disclosure. The system 100, which may be computer-implemented, comprises a generator network or generative network (GN) 110 and a conditioning network (CN) 120. For training purposes, the system 100 may further comprise one or more auxiliary networks 130. Inputs to the system include a noisy/distorted signal y, 10, a random vector (noise vector, random noise vector) z, 20, first side information s, 50, and second side information s, 55. The system 100 outputs an enhanced audio signal (clean audio signal) x, 30. As described in more detail below, the first and second side information may be identical.

The generator network 110 is a neural network for generating the enhanced audio signal (clean audio signal) x, 30. It comprises a plurality of layers (e.g., convolutional layers, transformer layers, recurrent neural network layers). The generator network 110 takes two inputs, namely the random vector (random noise vector) z, 20 and conditioning information 40, and produces the clean signal x, 30. The random vector z, 20 will provide the necessary variability for the generative model (e.g., generator network 110). The conditioning information 40 comprises one or more conditioning signals c that define the characteristics of the synthesized clean audio signal x, 30. Using the plurality of layers, the generator network 110 may perform multiple upsampling or downsampling operations, so that internal representations of the generator network 110 may have different temporal resolution.

Optionally, the generator network 110 may further receive the second side information s, 55 as input. The processing of the noise vector z, 20 by the generator network 110 may then depend, at least in part, on the second side information 55. The second side information 55 may include a potential subset of: a numeric description of the type and strength of artifacts present in y, the level of noise present in y, the (enhancement) operation that has to be performed by the system 100 (that is, for instance, whether it just needs to remove a particular artifact or perform full enhancement), or any other available additional information for the correct/intended operation of the network (for instance, information on characteristics of the audio signal y, including one or more of a description of speaker identity, language, room/microphone characteristics, etc.).

To obtain conditioning signals c (conditioning information 40) for the generator network 110, the conditioning network 120 is used. The conditioning network 120 comprises a plurality of layers (e.g., convolutional layers). It takes the noisy/distorted signal y as input, optionally together with the first side information s, 50. The first side information 50 may be the same as the second side information 55 described above, or it may be different from the second side information 55. The conditioning network 120 may be said to be in charge of performing the main enhancement operation. Nevertheless, at least part of the enhancement could be also performed by the generator network 110 if the whole system 100 is trained end-to-end. For instance, it could be the case that, despite the enhancement produced by the auxiliary losses (described in more detail below), conditioning signals c (conditioning information 40) still contain some artifact due to the original noise in the audio signal y, 10. Then the generator network 110 could still learn to filter such noise as the enhanced audio signal x, 30, is compared to clean signals.

Using the plurality of layers, the conditioning network 120 may perform multiple upsampling or downsampling operations, so that internal representations of the conditioning network 120 may have different temporal resolution. For example, for 16 kHz input audio, different temporal resolutions may relate to any or all of 16 kHz, 8 kHz, 2 kHz, 500 Hz, and 100 Hz. Further, for 32 kHz input audio, the different temporal resolutions may relate to any or all of 32 kHz, 8 kHz, 2 kHz, 500 Hz, and 100 Hz.

A summary of the operation of the system 100 is as follows. The conditioning network 120 is configured to receive the (noisy/distorted) audio signal y, 10 as input. It then propagates the audio signal y, 10 through the plurality of layers (e.g., convolutional layers), in the sense that the audio signal y, 10 is successively processed by the plurality of layers, with the output of one layer being used for an input to the next layer (and potentially for input to residual and/or skip connections). While doing so, the condition network 120 provides one or more first internal representations of the audio signal (or processed versions of the one or more first internal representations) as the conditioning information 40 (i.e., as the conditioning signals) or part of the conditioning information. These one or more first internal representations of the audio signal are extracted at respective layers of the conditioning network 120. For example, the plurality of layers of the conditioning network may comprise one or more intermediate layers, and the one or more first internal representations of the audio signal may be extracted from the one or more intermediate layers. In any case, the first internal representations of the conditioning information may relate to a hierarchy of representations of the audio signal, at different temporal resolutions.

In general, the conditioning information c, 40 may comprise the conditioning signals and may be provided to the generator network 110 potentially with other relevant information such as noise levels, target speaker, degradation to be kept (e.g., if the original reverb in the room is to be preserved), etc., for example. The conditioning signals can either be raw (e.g., unprocessed) versions of the first internal representations or processed versions of the first internal representations.

The generator network 110 on the other hand is configured to receive the noise vector z, 20 and the conditioning information c, 40 as input. Based on the noise vector z, 20 and the conditioning information c, 40 the generator network 110 generates the enhanced audio signal (clean signal) x, 30. Therein, each first internal representation (or processed version thereof) of the conditioning information 40 is combined with a respective second internal representation in the generator network 110. Here, combining for purposes of conditioning may mean, without intended limitation, at least one of adding, multiplying, and concatenating, for example. One implementation uses addition and multiplication. The second internal representations may be present at respective layers of the generator network 110. For example, the second internal representations may be outputs of respective layers of the generator network 110. It is understood, without intended limitation, that first and second internal representations that are combined for conditioning may have the same temporal resolution. In some implementations however, the first and second internal representations may be combined at different temporal resolutions by temporal resampling.

To be able to enhance the input signal y, the conditioning network 120 may be trained using one or more third internal representations h, 60 extracted from respective layers of the conditioning network 120. For training, these internal representations h may be sent to the auxiliary neural networks (auxiliary network blocks) 130 and auxiliary loss functions. Importantly, h, 60 can correspond to a hierarchy of representations (for instance obtained by downsampling y or upsampling a latent representation of the conditioning network 120), be directly related to c, 40 (for instance, correspond to c, 40 itself), or be a further processed version of c, 40 (that is, a representation obtained from c, 40 through one or more additional neural network layers).

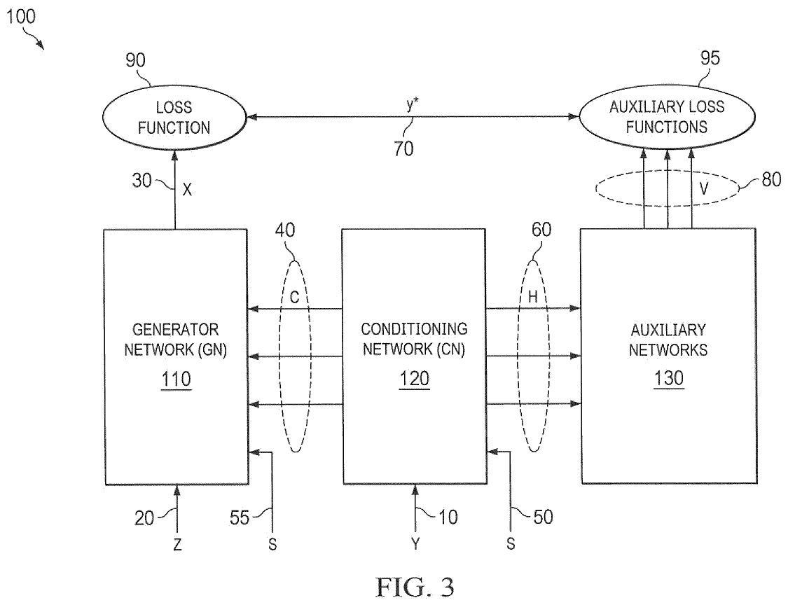

Auxiliary networks 130 for use in training can correspond to a single linear layer or to more elaborated structures, as described in more detail below with reference to FIG. 3. Auxiliary losses compare noisy/distorted representations h, 60 with clean ones, to which x, 30 will also be compared. Losses can correspond to a simple Lp norm of the difference between them or to more elaborated formulations, as described in more detail below. The comparison of such representations may be performed for example at the level of audio features (such as mel band spectral representations, loudness, pitch, harmonicity/periodicity, voice activity detection, and zero-crossing rate, for example) and of the raw audio waveform. However, other representation levels could be considered as well, such as latent features of a pre-trained neural network model or representations learned in a contrastive manner, like the ones learned in self-supervised models like HuBERT or wav2vec, for example.

It is to be understood that the auxiliary networks 130 shown in FIG. 1 are strictly necessary only for training purposes. At inference, the auxiliary networks 130 may be optional. In some cases however, providing one or more auxiliary networks 130 at inference may be beneficial for obtaining additional information on the enhanced speech signal, such as classification information, etc.

Auxiliary networks may be beneficial for the speech enhancement process in two ways: (a) they may decouple any errors made by the loss from the main signal path and (b) they may allow for hidden representations to be different from the loss calculation domain.

For advantage (a), network predictions will never be perfect and will always contain (few, but unavoidable) errors. If such error is made directly in the signal path, it will be cascaded/amplified with further processing. On the other hand, if the error is made a number of layers away from the signal path (i.e., the hidden representation), there is some opportunity for the main network to learn to obscure that error and to avoid propagation through the signal path.

For advantage (b), using auxiliary networks allows the hidden representations to have whatever form decided/needed by the network or learning process. To do so, the auxiliary networks use a number of layers to transform the internal representation to the loss domain (for example, the short-time Fourier transform, where a mean square error loss may be calculated). In this way, unnecessary transformations in the main path that are not necessary for inference time can be avoided, noting that these transformations may be just necessary for training and loss calculation.

Optional use of additional auxiliary networks at inference time is based on the fact that the internal representations learned for enhancement may provide some cues for additional tasks like speaker classification and vice-versa, so that by forcing the enhancement network to differentiate between speakers at training time could lead to an enrichment of the enhancement process.

An embodiment of the system 100 uses a diffusion-based model for the generator network 110. Alternatively, the generator network 110 could also consist of or comprise a variational autoencoder, an autoregressive model, or be based on a GAN formulation, among others. Further, the architecture of the generator network 110 may be based on a UNet structure. The UNet structure may comprise, for example, skip connections and/or residual connections in its inner convolutional blocks. Further, the UNet structure may comprise a recurrent neural network (RNN) in the middle. Other deep learning architectures and blocks could be added or interchanged with the aforementioned ones, such as a WaveNet or a Transformer architecture, or conformer, perceiver, inception, or squeeze-and-excitation blocks, for example.

The architecture of the conditioning network 120 may be based on an encoder-decoder structure, for example using ResNets, optionally with skip connections in the encoder. Like the generator network 110, also the conditioning network 120 may use convolutional blocks with an RNN in the middle (e.g., after the encoder and skip connections). The conditioning signals c (e.g., first internal representations or processed versions thereof) may be extracted from different levels of the decoder structure, composing a hierarchy of different sampling speeds. Third internal representations h, 60 may be extracted after the encoder (using downsampling) and decoder (using upsampling) blocks. In general, conditioning information c, 40 (conditioning signals) and third internal representations h, 60 could be extracted from any point in conditioning network 120.

A specific implementation uses convolutional blocks and a couple of bi-directional recurrent layers for the generator network 110, the conditioning network 120, and optionally the auxiliary networks 130. The convolutional blocks may be formed by three 1D convolutional layers, each one preceded by a multi-parametric ReLU (PRELU) activation, and all of them under a residual connection. If needed, up- or down-sampling may be applied before or after the residual link, respectively. Up-/down-sampling may be performed with transposed/strided convolutions, halving/doubling the number of channels at every step, for example. The down-sampling factors may be {2,4,4,5}, for example, which would yield a 100 Hz latent representation for a 16 kHz input.

In the specific implementation, the generator network 110 may be formed by a UNet-like structure with skip connections v and a gated recurrent unit (GRU) in the middle. Convolutional blocks in the generator may receive adaptor signals g, which inform the network about the noise level σ, and the conditioning signals c, which provide the necessary speech cues for synthesis. Signals g and c may be mixed with the UNet activations using Feature-wise Linear Modulation (FiLM) and summation, respectively. To obtain g, the logarithm of σ may be processed with random Fourier feature embeddings and a Multilayer Perceptron (MLP). The conditioning network processes the distorted signal y with convolutional blocks featuring skip connections to a down-sampled latent that may for example further exploit log-mel features extracted from y. The middle and decoding parts of the network may be formed by a two-layer GRU and multiple convolutional blocks, with the decoder up-sampling the latent representation to provide multi-resolution conditionings c to the generator network 110. Multiple heads and target information may be exploited to improve the latent representation and provide a better c.

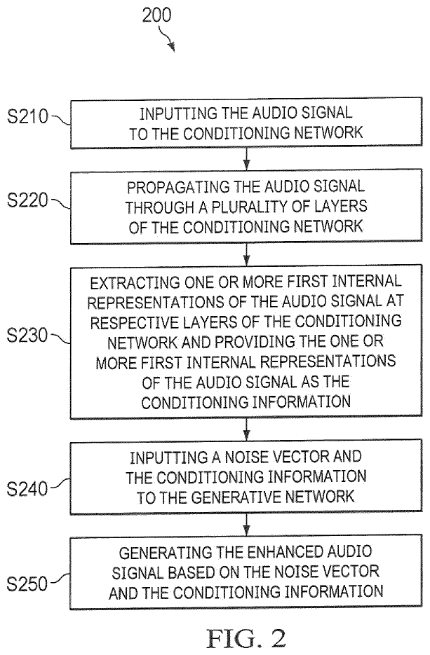

FIG. 2 illustrates an example method 200 of processing an audio signal 10, for example for purposes of speech enhancement, using the neural network based system 100 described above. In particular, the neural network based system 100 is understood to comprise a generative network (generator network) 110 for generating an enhanced audio signal 30 and a conditioning network 120 for generating conditioning information 40 for the generative network 110. Method 200 comprises steps S210 through S250.

At step S210, the audio signal y, 10 is input to the conditioning network 120. Optionally, first side information 50 as described above may be provided to the conditioning network 120 as additional input.

At step S220, the audio signal y, 10 is propagated through a plurality of layers of the conditioning network 120. That is, the audio signal y, 10 is successively processed by the multiple layers (e.g., convolutional layers) of the conditioning network 120.

At step S230, one or more first internal representations (e.g., conditioning signals) of the audio signal are extracted at respective layers of the conditioning network 120. These first internal representations may relate to a hierarchy of representations of the audio signal, at different temporal resolutions. The one or more first internal representations of the audio signal (or processed versions thereof) are provided as the conditioning information c, 40 for the generator network 110.

At step S240, a noise vector 20 (random vector, random noise vector) and the conditioning information 40 are input to the generative network 110. Optionally, second side information 55 as described above may be provided to the generator network 110 as additional input.

At step S250, the enhanced audio signal 30 is generated based on the noise vector 20 and the conditioning information 40. Optionally, if available, generating the enhanced audio signal 30 may be further based on the second side information 55.

Here, the conditioning information (e.g., the first internal representations extracted from the conditioning network 120 or processed versions thereof) may be used for conditioning the generator network 110, using techniques readily available to the skilled person. For example, each first internal representation (or processed version thereof) of the conditioning information 40 may be combined with a respective second internal representation in the generative network 110. It is understood that any combined first and second internal representations may have the same temporal resolution. Examples of combining internal representations for purposes of conditioning may include one or more of addition (e.g., element-wise), multiplication (e.g., element-wise), and concatenation. One implementation uses addition and multiplication for combining the internal representations.

A neural network based system and a method of enhancing speech using this system have been described above. It is understood that the system has been appropriately trained prior to inference. This training may use data pairs (y,y*), corresponding to distorted versions y and clean versions y* of the same audio signal (e.g., speech signal). The distorted versions y comprise noise and/or artifacts and may be generated, from respective clean versions y*, by programmatic transformation of the clean version y* and/or addition of noise. Alternatively, y and y* may relate to recorded versions of (real-world) distorted and clean audio (i.e., manually generated training data), respectively. Such recorded versions may be obtained from the relevant databases, for example.

FIG. 3 schematically illustrates the neural network based system 100 for speech enhancement (e.g., universal speech enhancement) during training. The system corresponds to the one shown in FIG. 1, with the difference that the auxiliary networks 130 are not optional for training. Further shown in FIG. 3 are a loss function 90 and auxiliary loss functions 95 that are used for evaluating outputs of the generator network 110 and the auxiliary networks 130, respectively.

Even though this is not necessarily the case, the generator network 110 and the conditioning network 120 may be jointly trained in some implementations. Further, the generator network 110, the conditioning network 120, and the auxiliary networks 130 may be jointly trained in some implementations.

To be able to enhance the input signal y, 10, the conditioning network 120 needs to be trained using the one or more auxiliary networks 130, as noted above. One or more third internal representations h, 60 are extracted from the conditioning network 120 and sent to respective auxiliary neural networks 130 with respective loss functions 95. Importantly, h can correspond to a hierarchy of representations (for instance obtained by downsampling y and/or upsampling a latent representation of the conditioning network 120), be directly related to c, 40 (for instance correspond to c itself), or be a further processed version of c (e.g., a representation obtained from c through one or more additional neural network layers). The auxiliary networks 130 process the one or more third internal representations h, 60 to yield processed versions v, 80 thereof.

The auxiliary networks 130 can correspond to a single linear layer (e.g., convolutional layer) or to more elaborated structures. For example, the architecture of the auxiliary networks 130 (e.g., one per each third internal representation h) may correspond to a mixture density network (MDN), for example with previous layer normalization and parametric rectified linear units activation. It is to be understood however that any other neural network block could be used as well.

The auxiliary losses 95 compare noisy/distorted representations with clean ones, to which the enhanced audio signal x, 30 will also be compared. The third internal representations 60, after processing by respective auxiliary neural networks 130, are compared to representations of the clean audio signal y*, 70 or audio features derived from the clean audio signal y*. Losses can correspond to a simple Lp norm of the difference between them or to more elaborated formulations. For example, the auxiliary losses 95 may correspond to negative log-likelihoods computed with the MDN, but other losses could be used as well, such as Lp norms, maximum mean discrepancy, or adversarial or feature losses, for example. The main loss function 90 for comparing the enhanced audio signal x, 30 and the clean audio signal y*, 70 may depend on the generative model chosen for the generator network 110.

The comparison of representations to clean versions may be performed at the level of audio features (e.g., mel band spectral representations, loudness, pitch, harmonicity/periodicity, voice activity detection, and zero-crossing rate) and of the raw audio waveform. However, other representation levels could be considered as well, such as latent features of a pre-trained neural network model or representations learned in a contrastive manner, like representations learned in self-supervised models like HuBERT or wav2vec, for example.

In general, considering more than one loss for training (i.e., ensembling, as enabled by using one or more auxiliary networks 130) may improve quality of the training results. Namely, it is almost never the case that a loss can be found that is perfect for a given task. Typically, there may be several imperfect, but still usable losses (e.g., usable as a proxy). Instead of just selecting one particular loss, it is thus proposed to “ensemble” different losses. This may involve using these losses concurrently, noting that agreement needs to be reached in the internal representations, and that this agreement will facilitate a better representation than using a single loss.

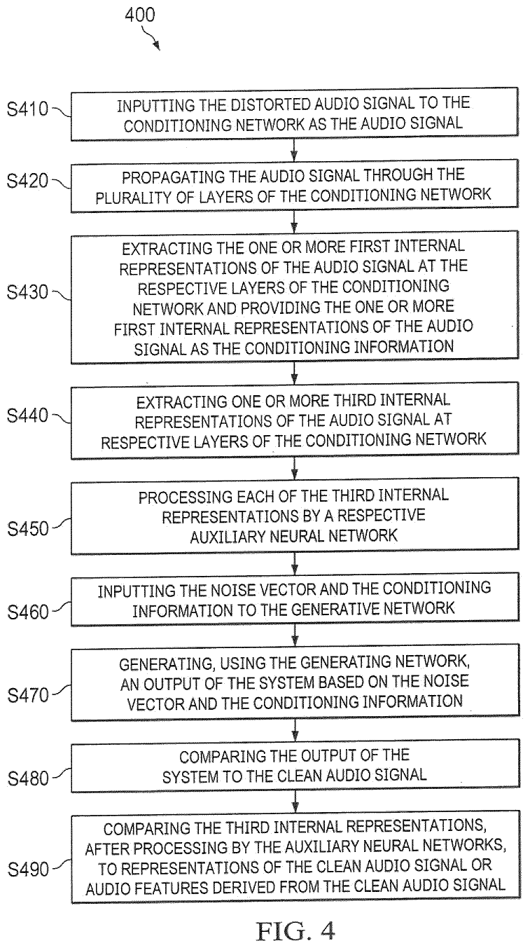

An example training procedure or method for the neural network based system 100 will be described next with reference to FIG. 3 and FIG. 4. Of these, FIG. 4 shows a flowchart of an example method 400 of training the neural network based system 100. Method 400 comprises steps S410 through S490, which do not necessarily need to be performed in the order shown in the figure.

The input is a clean signal y*, 70, a distorted signal y, 10, and a random vector z, 20 (e.g., random noise vector z). Notably, the input does not necessarily include side information. The clean signal y*, 70 and the distorted signal y, 10 may correspond to a data pair (y*,y) that may be created as described above, for example. Steps S410 to S490 may be performed for each of a plurality of data pairs (y*,y).

At step S410, the distorted audio signal 10 is input to the conditioning network 120 as the audio signal. This step may correspond to step S210 of method 200 described above with reference to FIG. 2.

At step S420, the audio signal 10 is propagated through the plurality of layers of the conditioning network 120. This step may correspond to step S220 of method 200 described above.

At step S430, the one or more first internal representations of the audio signal are extracted at the respective layers of the conditioning network. The one or more first internal representations of the audio signal (or processed versions of the one or more first internal representations) are provided as the conditioning information c, 40. This step may correspond to step S230 of method 200 described above.

At step S440, one or more third internal representations 60 of the audio signal are extracted at respective layers of the conditioning network 120.

At step S450, each of the third internal representations 60 is processed by a respective auxiliary neural network 130.

At step S460, the noise vector 20 and the conditioning information 40 are input to the generative network 110. This step may correspond to step S240 of method 200 described above.

At step S470, an output of the system is generated, using the generating network 110, based on the noise vector 20 and the conditioning information 40. This step may correspond to step S250 of method 200 described above.

At step S480, the output of the system (i.e., the enhanced audio signal x, 30) is compared to the clean audio signal y*, 70. This may be done using the (main) loss function 90 described above. The comparison may be at the level of waveforms, for example.

At step S490, the third internal representations 60, after processing by the auxiliary neural networks 130 (yielding processed versions v, 80), are compared to representations of the clean audio signal y*, 70 or audio features derived from the clean audio signal y*, 70. These audio features may comprise at least one of mel band spectral representations, loudness, pitch, harmonicity/periodicity, voice activity detection, zero-crossing rate, self-supervised features from an encoder, self-supervised features from a wave2vec model, and self-supervised features from a HuBERT model, for example. It is understood that each processed version v, 80 of a respective third internal representation h, 60 is compared to an appropriately processed version of the clean audio signal y*, 70, using a respective auxiliary loss function 95.

Comparing the output of the system to the clean audio signal 70 at step S480 and/or comparing the third internal representations 60 to representations of the clean audio signal 70 or audio features derived from the clean audio signal 70 at step S490 may be based on respective loss functions 90, 95. These loss functions may relate to one or more of negative log-likelihoods, Lp norms, maximum mean discrepancy, adversarial losses, and feature losses, for example.

Finally, the error of all losses may be summed, and the gradient may be backpropagated through the networks, for training the system and successively adapting coefficients and parameters of the system.

In some implementations, also first and second side information 50, 55 may be provided as inputs to the conditioning network 120 and the generator network 110, respectively, during training.

As can be seen from the above, the conditioning network 120, the generative network 110, and the one or more auxiliary neural networks 130 can be jointly trained in some implementations. In line with the above, an example of training of the neural network based system may also be summarized as follows:
1) y enters the conditioning network and is forwarded through several layers.
2) Intermediate representation h1 is extracted and kept for later.
3) Intermediate representation h1 is forwarded through several other layers. Conditioning representations c are extracted at intermediate blocks and kept for later. Notably, the order of extracting h1 and c may be arbitrary.
4) Final representation of the conditioning network is obtained: h2. Any other representation other than the final representation may be obtained as h2 as well. In some implementations, additional representations hx may be extracted.
5) z enters the generator network and is forwarded through several layers. At every intermediate block of layers (i.e., at appropriate layers), the contents of the internal representation are merged (e.g., combined) with conditioning representations c.
6) Output clean signal x is produced by the GN.
7) h1 and h2 (and possibly additional internal representations hx) are forwarded through one or several layers of the auxiliary networks. Output representations v1 and v2 (and possibly additional output representations vx) are obtained.
8) A loss function is computed for v1 and v2 (and possibly for additional output representations vx). For instance, v2 can be compared to raw clean audio y* and v1 can be compared to classical speech features f* extracted from y*.
9) A loss function is computed for x, comparing it with y*.
10) The error of all losses is summed, and the gradient is backpropagated through the networks.

An example of an inference application would be, in line with method 400, as follows: Steps 1) to 6) as above, omitting steps 7) to 10). The input is just the distorted signal y and a random vector z, and optionally, side information.

While a system architecture of the neural network based system and corresponding methods have been described above, it is understood that the present disclosure likewise relates to apparatus for implementing the system or method.

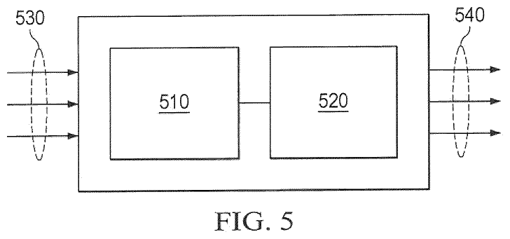

FIG. 5 schematically illustrates an example of an apparatus 500 for implementing neural network based systems and neural network based techniques according to embodiments of the disclosure. The apparatus comprises a processor 510 and a memory 520 coupled to the processor 510. The memory 520 stores instructions for execution by the processor 510. The processor 510 is adapted to implement neural network based systems described throughout the disclosure and/or to perform methods (e.g., methods of speech enhancement) described throughout the disclosure. The apparatus 500 may receive inputs 530 (e.g., distorted audio signals, data pairs of clean and distorted audio signals, side information, etc.) and generate outputs 540 (e.g., enhanced audio signals, internal representations for training, etc.).

### Interpretation

Aspects of the systems described herein may be implemented in an appropriate computer-based sound processing network environment (e.g., server or cloud environment) for processing digital or digitized audio files. Portions of the disclosed systems may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, computer-implemented neural networks described herein can include one or more electronic processors, one or more computer-readable medium modules, one or more input/output interfaces, and various connections (e.g., a system bus) connecting the various components.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### Enumerated Example Embodiments

Various Aspects an implementations of the invention may also be appreciated from the following enumerated example embodiments (EEEs), which are not claims.

EEE1. A system for universal speech enhancement of a distorted audio signal, the system comprising:
a conditioning network comprising a plurality of layers, the conditioning network configured to: receive, as input, at least the distorted audio signal, y; extract one or more representations, h, from one or more layers of the plurality of layers; extract one or more conditioning representations, c, from one or more layers of the plurality of layers;
a generative network configured to generate a clean signal, x, based on at least a random vector, z, and the one or more conditioning representations, c; and
one or more auxiliary networks configured to: enhance the distorted audio signal based on a comparison of h with a clean audio signal y* and/or x with y*, wherein y and y* correspond to distorted and clean versions of a same speech, respectively.

EEE2. The system of EEE1, wherein the conditioning neural network is further configured to receive, as input, side information.

EEE3. The system of EEE2, wherein the side information comprises at least one of a numeric (or textual) description of a type of artifacts present in y, a numeric description of a strength of artifacts present in y, a level of noise present in y, an enhancement operation to be performed by the system, a description of speaker identity, a type of language, a room characteristic, and/or a microphone characteristic.

EEE4. The system of EEE1 or EEE2, wherein the plurality of layers comprise one or more intermediate layers.

EEE5. The system of EEE4, wherein the one or more representations, h, are extracted from the one or more intermediate layers.

EEE6. The system of EEE4 or EEE5, wherein the one or more conditioning representations, c, are extracted from the one or more intermediate layers.

EEE7. The system of any of EEE1 to EEE6, wherein the one or more representations, h, comprise at least a hierarchy of representations, are directly related to c, or are a further processed version of c.

EEE8. The system of any of EEE1 to EEE7, wherein the comparison comprises computing a loss function based on y* and h and/or y* and x.

EEE9. The system of EEE8, wherein computing the loss function comprises comparing h and y* based on audio features of h and of y*.

EEE10. The system of EEE9, wherein the audio features comprise at least one of mel band spectral representations, loudness, pitch, harmonicity/periodicity, voice activity detection, zero-crossing rate, self-supervised features from an encoder, self-supervised features from a wave2vec model, and/or self-supervised features from a HuBERT model.

EEE11. The system of any of EEE1 to EEE7, wherein enhancing the distorted audio signal based on a computed loss function of h and y* and/or x and y* comprises comparing h and y* and/or x and y* based on at least one of a raw audio waveform representation level, a latent space representation level, or a representation level learned in a contrastive manner.

EEE12. The system of any of EEE1 to EEE11, wherein for each one of the one or more representations, h, there is a corresponding auxiliary network.

EEE13. The system of any of EEE1 to EEE12, wherein the one or more auxiliary networks are configured based on a mixture density network.

EEE14. The system of any of EEE1 to EEE13 when dependent on EEE7, wherein the computed loss function comprises at least one of negative log-likelihoods, Lp norms, maximum mean discrepancy, adversarial losses, and/or feature losses.

EEE15. The system of any of EEE1 to EEE14, wherein the conditioning neural network is configured based on an encoder-decoder structure using ResNets, wherein the encoder structure comprises skip connections.

EEE16. The system of any of EEE1 to EEE15, wherein the generative neural network is configured based on at least a diffusion-based model, a variational autoencoder, an autoregressive model, or a Generative Adversarial Network formulation.

EEE17. The system of any of EEE1 to EEE16, wherein the generative neural network is configured based on a UNet structure comprising both skip and residual connections in inner layers of the plurality of layers and wherein the generative neural network further comprises a recurrent neural network.

1. A neural network based system for speech enhancement of an audio signal, the system comprising a generative network for generating an enhanced audio signal and a conditioning network for generating conditioning information for the generative network,
wherein the conditioning network comprises a plurality of layers and is configured to:
receive the audio signal as input;
propagate the audio signal through the plurality of layers; and
provide one or more first internal representations of the audio signal or processed versions thereof as the conditioning information, wherein the one or more first internal representations of the audio signal are extracted at respective layers of the conditioning network; and
wherein the generative network is configured to:
receive a noise vector and the conditioning information as input; and
generate the enhanced audio signal based on the noise vector and the conditioning information.

2. The system according to claim 1, wherein the first internal representations of the conditioning information relate to a hierarchy of representations of the audio signal, at different temporal resolutions.

3. The system according to claim 1, wherein each first internal representation of the conditioning information or a processed version thereof is combined with a respective second internal representation in the generative network.

4. The system according to claim 1, wherein the conditioning network is further configured to receive first side information as input, and wherein processing of the audio signal by the conditioning network depends on the first side information.

5. The system according to claim 4, wherein the first side information comprises a numeric description of one or more of: a type of artifact present in the audio signal, a level of noise present in the audio signal, an enhancement operation to be performed on the audio signal, and information on characteristics of the audio signal.

6. The system according to claim 1, wherein the generative network is further configured to receive second side information as input, and wherein processing of the noise vector by the generative network depends on the second side information.

7. The system according to claim 6, wherein the second side information comprises a numeric description of one or more of: a type of artifact present in the audio signal, a level of noise present in the audio signal, an enhancement operation to be performed on the audio signal, and information on characteristics of the audio signal.

8. The system according to claim 1, wherein the plurality of layers of the conditioning network comprise one or more intermediate layers, and wherein the one or more first internal representations of the audio signal are extracted from the one or more intermediate layers.

9. (canceled)

10. The system according to claim 1, wherein the conditioning network is based on an encoder-decoder structure, wherein the encoder-decoder structure uses ResNets and/or the encoder part of the encoder-decoder structure comprises one or more skip connections.

11. The system according to claim 1, wherein the generative network is based on one of a diffusion-based model, a variational autoencoder, an autoregressive model, and a Generative Adversarial Network formulation.

12. The system according to claim 1, wherein the generative network is based on an encoder-decoder structure, wherein the encoder-decoder structure uses ResNets and/or the encoder part of the encoder-decoder structure comprises one or more skip connections.

13. The system according to claim 1, wherein the system has been trained prior to inference, using data pairs each comprising a clean audio signal and a distorted audio signal corresponding to or derived from the clean audio signal, and wherein the distorted audio signal comprises noise and/or artifacts, wherein one or more of the data pairs comprise a respective clean audio signal and a respective distorted audio signal that has been generated by programmatic transformation of the clean audio signal and/or addition of noise, and wherein the programmatic transformation comprises one or more of adding reverberation, low-pass filtering, clipping, packet loss simulation, transcoding, random equalization and level dynamics distortion.

14. (canceled)

15. The system according to claim 13, wherein the conditioning network is further configured to provide one or more third internal representations of the audio signal for training, the one or more third internal representations of the audio signal being extracted at respective layers of the conditioning network;
wherein the system has been trained, for each data pair, based on a comparison of the clean audio signal to an output of the system when the distorted audio signal is input to the conditioning network as the audio signal, and further based on a comparison of representations of the clean audio signal or audio features derived from the clean audio signal to the third internal representations, after processing of the third internal representations by respective auxiliary neural networks; and
wherein the comparisons are based on respective loss functions.

16. (canceled)

17. The system according to claim 15, wherein the audio features comprise at least one of mel band spectral representations, loudness, pitch, harmonicity/periodicity, voice activity detection, zero-crossing rate, self-supervised features from an encoder, self-supervised features from a wave2vec model, and self-supervised features from a HuBERT model.

18. The system according to claim 15, wherein there is one respective auxiliary neural network for each third internal representation extracted from the conditioning network.

19. The system according to claim 15, wherein the one or more auxiliary neural networks are based on mixture density networks.

20. (canceled)

21. A method of processing an audio signal for speech enhancement using a neural network based system, wherein the system comprises a generative network for generating an enhanced audio signal and a conditioning network for generating conditioning information for the generative network, the method comprising:
inputting the audio signal to the conditioning network;
propagating the audio signal through a plurality of layers of the conditioning network;
extracting one or more first internal representations of the audio signal at respective layers of the conditioning network and providing the one or more first internal representations of the audio signal or processed versions thereof as the conditioning information;
inputting a noise vector and the conditioning information to the generative network; and
generating the enhanced audio signal based on the noise vector and the conditioning information.

22. The method according to claim 21, wherein the first internal representations of the conditioning information relate to a hierarchy of representations of the audio signal, at different temporal resolutions.

23. The method according to claim 21, further comprising combining each first internal representation of the conditioning information or a processed version thereof with a respective second internal representation in the generative network.

24. The method according to claim 21, further comprising inputting first side information to the conditioning network and/or inputting second side information to the generative network.

25-33. (canceled)
